(19) United States
(12) Patent Application Publication
(10) Pub. No.: US 2026/0313488 A1
(43) Pub. Date: Oct. 8, 2026

(54) Indicating LTM Candidate after Execution

(71) Applicant: Telefonaktiebolaget LM Ericsson (publ), Stockholm (SE)

(72) Inventors: Pontus Wallentin, Linköping (SE); Antonino Orsino, Kirkkonummi (FI); loanna Pappa, Stockholm (SE)

(21) Appl. No.: 19/482,234

(22) PCT Filed: Apr. 30, 2024
(86) PCT No.: PCT/SE2024/050414

§ 371 Date: Nov. 7, 2025

Related U.S. Application Data
(60) Provisional application No. 63/464,817, filed on May 8, 2023.

(51) Int. Cl. H04W 36/00; H04W 36/12

(52) U.S. Cl. CPC H04W 36/00835; H04W 36/125

(57) ABSTRACT

Methods, apparatuses, and systems for improved Layer-1/Layer-2-triggered mobility (LTM) in a wireless network An example method, for a user equipment, UE, comprises receiving (910), from the wireless network, an LTM candidate cell configuration, executing (930) a first LTM cell switch procedure; and transmitting (940) an LTM cell switch complete message to the wireless network, the LTM cell switch complete message including an indication of an applied LTM candidate.

### TECHNICAL FIELD

The present application relates generally to the field of wireless networks, and more specifically to mobility of user equipment (UEs) across multiple cells in a wireless network, specifically mobility based on layer-1 (L1) and/or layer-2 (L2) procedures, referred to as L1/L2-triggered mobility, or “LTM.”

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of the 5G network architecture, consisting of a Next Generation RAN (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. 5GC 198 can include various other network functions (NFs), such as Session Management Function(s) (SMF).

Although not shown, in some deployments 5GC 198 can be replaced by an Evolved Packet Core (EPC), which conventionally has been used together with a Long-Term Evolution (LTE) Evolved UMTS RAN (E-UTRAN). In such deployments, gNBs 100, 150 can connect to one or more Mobility Management Entities (MMEs) in EPC 198 via respective S1-C interfaces. Similarly, gNBs 100, 150 can connect to one or more serving Gateways (SGWs) in EPC via respective NG-U interfaces.

The gNBs can be connected to each other via one or more Xn interfaces, such as Xn interface 140 between gNBs 100 and 150. The radio technology for the NG-RAN is often referred to as “New Radio” (NR). With respect to the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs are logical nodes that host higher-layer protocols and perform various gNB functions such controlling the operation of DUs, which are logical nodes that host lower layer protocols and can include various subsets of the gNB functions. As such, each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces, such as interfaces 122 and 132 shown in FIG. 1. A gNB-DU may be connected to multiple gNB-CUs by appropriate implementation. The gNB-CU and connected gNB-DU(s) are only visible to other gNBs and the 5GC as a gNB. In other words, the F1 interface is not visible beyond gNB-CU.

Dual connectivity (DC) was introduced in LTE Rel-12. In DC operation, a UE in RRC_CONNECTED state consumes radio resources provided by at least two different network nodes connected to one another with a non-ideal backhaul. Several DC (or more generally, multi-connectivity) arrangements are also supported in 5G/NR. These include NR-DC that is like LTE DC except that both network nodes use the NR interface to communicate with the UE, as well as various multi-RAT DC (MR-DC) involving both LTE and NR access by the same UE. More generally, one node acts as a master node (MN) providing the UE's master cell group (MCG) and another node acts as a secondary node (SN) providing the UE's secondary cell group (SCG), with at least the MN being connected to a core network (e.g., EPC or 5GC).

Each of the CGs includes one MAC entity, a primary cell (PCell), and optionally one or more secondary cells (SCells). The term “Special Cell” (or “SpCell” for short) refers to the PCell of the MCG or the PCell of the SCG (also referred to as “PSCell”) depending on whether the UE's MAC entity is associated with the MCG or the SCG, respectively. In non-DC operation (e.g., carrier aggregation, CA), SpCell refers to the PCell. An SpCell is always activated and supports physical UL control channel (PUCCH) transmission and contention-based random access by UEs.

When the UE moves between the coverage areas of two cells, a serving cell change needs to be performed at some point. Currently, serving cell change is triggered by layer 3 (L3, e.g., RRC) measurements and involves RRC signaling to change PCell and/or PSCell (e.g., when dual connectivity is configured), as well as release/add SCells (e.g., when CA is configured). For example, a handover command is sent by an RRCReconfiguration message that includes a reconfigurationWithSync information element (IE).

Currently, L3 inter-cell mobility involves complete layer 2 (L2) and layer 1 (L1, i.e., PHY) resets, leading to longer latency, increased signaling overhead, and longer interruptions than for intra-cell beam switching. To address these issues, NR Rel-18 included a Work Item on NR mobility enhancements, which includes a feature referred to as L1/L2 based inter-cell mobility, L1/L2 triggered mobility (LTM), or lower layer-triggered mobility. This work item is further described in 3GPP document RP-213565. A goal of Rel-18 L1/L2 mobility (or LTM) enhancements is to facilitate serving cell change via L1/L2 signaling to reduce latency, signaling overhead, and interruptions associated with conventional L3 inter-cell mobility. Another Work Item in 3GPP is entitled “Further NR mobility enhancements” and is described in 3GPP RP-223520.

These work items specify objectives of the work:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   CU-DU interface signaling to support L1/L2 mobility, if needed [RAN3]
   Note 2: FR2 specific enhancements are not precluded, if any.
   Note 3: The procedure of L1/L2 based inter-cell mobility are applicable to the following scenarios:
      Standalone, CA and NR-DC case with serving cell change within one CG
      Intra-DU case and intra-CU inter-DU case (applicable for Standalone and CA: no new RAN interfaces are expected)
      Both intra-frequency and inter-frequency
      Both FR1 and FR2
      Source and target cells may be synchronized or non-synchronized

A basic principle of LTM is that the UE is pre-configured, by the network, with one RRC configuration per LTM candidate target cell. This pre-configured RRC configuration is sometimes referred to as an LTM candidate cell configuration. Such an LTM candidate cell configuration may be an RRCReconfiguration message or one or more IEs/fields/parameters such as CellGroupConfig.

After receiving these LTM candidate cell configurations, the UE performs measurements on these LTM candidate cells and transmits corresponding measurement reports to the network. The network then triggers the execution of a LTM cell switch in the UE to one of these LTM candidate cells by transmitting an LTM cell switch command (such as a MAC CE), to the UE, which then connects to the particular LTM candidate cell and switches to an RRC configuration of this LTM candidate cell.

Relevant agreements made by 3GPP working groups include:
Use the term “Subsequent” LTM for the case when cell switch between L1/L2 mobility candidates is done without RRC reconfiguration in between.
RAN2 assumes that sequential L1L2 cell change between Candidates without RRC reconfiguration can be supported.
RAN2 assumes the MAC CE for L1/2 mobility trigger contains at least a candidate configuration index.
RAN2 assumes that at L1L2 cell switch: Whether the UE performs partial or full MAC reset (FFS what partial reset is, e.g. to avoid data loss), re-establish RLC, perform data recovery with PDCP is explicitly controlled by the network. RAN2 assumes that this can be configured by RRC. FFS if MAC CE indication(s) is/are needed.
agree to use Model 1: One RRCReconfiguration message for each candidate target configuration RRCReconfiguration to configure target candidate cells
RAN2 assumes RRCReconfigurationComplete message is always sent at each LTM execution.
In RACH-based LTM, the target cell is aware of the UE's arrival based on the reception of preamble in CFRA and on the reception of Msg3/MsgA in CBRA, like the legacy handover (HO).
In RACH-less LTM, the target cell is aware of the UE's arrival based on reception of the first UL transmission from this UE.
In RACH-less LTM, RRCReconfigurationComplete can be the content of the first UL MAC PDU/transmission to indicate UE arrival, i.e. no need to introduce any new signaling to indicate UE arrival (for the MCG-switch case)

Further improvements to L1/L2-triggered mobility, or LTM, are needed.

### SUMMARY

In the detailed description that follows, several cases are described in which the consecutive performing of multiple LTM cell procedures a can cause problems in the network, because one or more involved nodes may be unable to reliably determine a UE's status because of signaling ambiguities caused by such things as race conditions in the network, poor signal conditions, etc. Several methods described below address these problems by having the UE indicate the applied LTM candidate configuration at LTM cell switch.

An example of such a method comprises receiving, from a network node, at least one LTM candidate cell configuration, executing an LTM cell switch procedure by applying the received indicated LTM candidate cell configuration, and transmitting, to a network node, such as a first target network node, a second target network node, or a third network node, an LTM cell switch complete message that includes an indication of applied LTM candidate. In various embodiments, the indication of applied LTM candidate may be an indication of the target cell, an indication of an LTM candidate cell configuration, an indication of a beam, or an identifier of a procedure, transaction or message instance.

Other techniques described herein include methods for a first target network node (such as a first target gNB, a first target DU), to handle an LTM cell switch procedure for a UE, where an example of such methods comprises receiving, from the UE, an LTM cell switch complete message including an indication of applied LTM candidate. Similarly, techniques described herein include methods for a second target network node (such as a second target gNB, a second target DU), to handle an LTM cell switch procedure for a UE, where an example method comprises receiving, from the UE, an LTM cell switch complete message including an indication of applied LTM candidate. Likewise, an example method for a third network node (or serving network node), such as a (serving) Central Unit (CU), (serving) gNB-CU to handle an LTM cell switch procedure for a UE, comprises transmitting, to the UE, at least one LTM candidate cell configuration and receiving, from the UE, an LTM cell switch complete message including an indication of applied LTM candidate upon sending an LTM cell switch command to initiate an LTM cell switch procedure.

An example method for L1/L2-triggered mobility in a wireless network according to some embodiments described herein is carried out by a UE. The method comprises receiving, from the wireless network, an LTM candidate cell configuration, executing a first LTM cell switch procedure, and transmitting an LTM cell switch complete message to the wireless network, the LTM cell switch complete message including an indication of an applied LTM candidate.

An example method for supporting LTM in a wireless network, according to some embodiments described herein, is carried out by a network node. The method comprises the step of receiving, from a UE, a first LTM cell switch complete message, the first LTM cell switch complete message including an indication of an applied LTM candidate.

The indication of an applied LTM candidate cell in the LTM cell switch complete message resolves any potential ambiguity that might otherwise arise in the event of multiple LTM procedures.

One or several of these techniques may be used to enable the network to know which LTM candidate cell configuration the UE has applied after execution of an LTM cell switch, in particular when the UE performs a first LTM cell switch shortly followed by a second, subsequent, LTM cell switch. As noted above and explained in further detail below, in these cases, the LTM cell switch complete message, such as an RRCReconfiguration complete message transmitted after the first LTM cell switch, may or may not have been received by the network when the second LTM cell switch was triggered.

These and other objects, features, and advantages of the present disclosure will become apparent upon reading the following Detailed Description in view of the Drawings briefly described below.

### BRIEF DESCRIPTION OF THE DRAWINGS

FIG. 1 and FIG. 2 illustrate two high-level views of an exemplary 5G/NR network architecture.

FIG. 3 shows an exemplary configuration of NR user plane (UP) and control plane (CP) protocol stacks.

FIG. 4 is a message sequence chart illustrating signaling for LTM in an inter-DU scenario.

FIG. 5 illustrates a system structure including entities involved in the techniques described herein.

FIG. 6 is a message sequence chart illustrating signaling and steps according to several embodiments of the techniques described herein for improving LTM.

FIG. 7A and FIG. 7B together provide another message sequence chart illustrating signaling and steps according to several embodiments of the techniques described herein for improving LTM.

FIG. 8A and FIG. 8B provide yet another message sequence chart illustrating signaling and steps according to several embodiments of the techniques described herein for improving LTM.

FIG. 9 is a process flow showing an example method for a UE.

FIG. 10—shows an exemplary method for a network node, according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objectives, features and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

To provide additional context for the techniques described in detail below, FIG. 2 shows a high-level view of an exemplary 5G network architecture, including an NG-RAN 299 and a 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to the access and mobility management functions (AMFs, e.g., 230a,b) via respective NG-C interfaces and to user plane functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the LTE radio interface. Unlike conventional LTE eNBs, however, ng-eNBs 220 connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

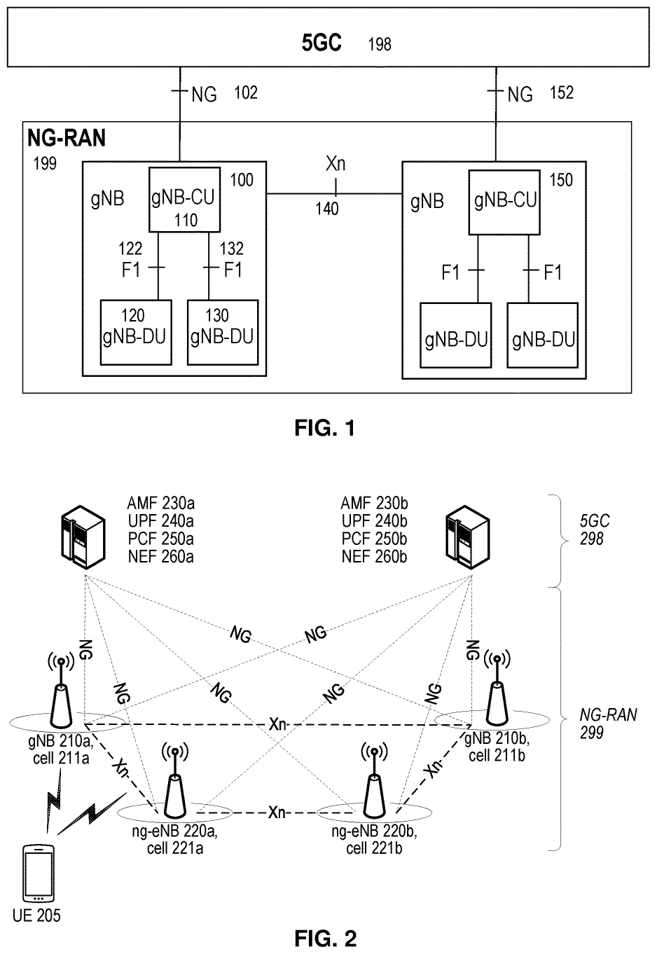

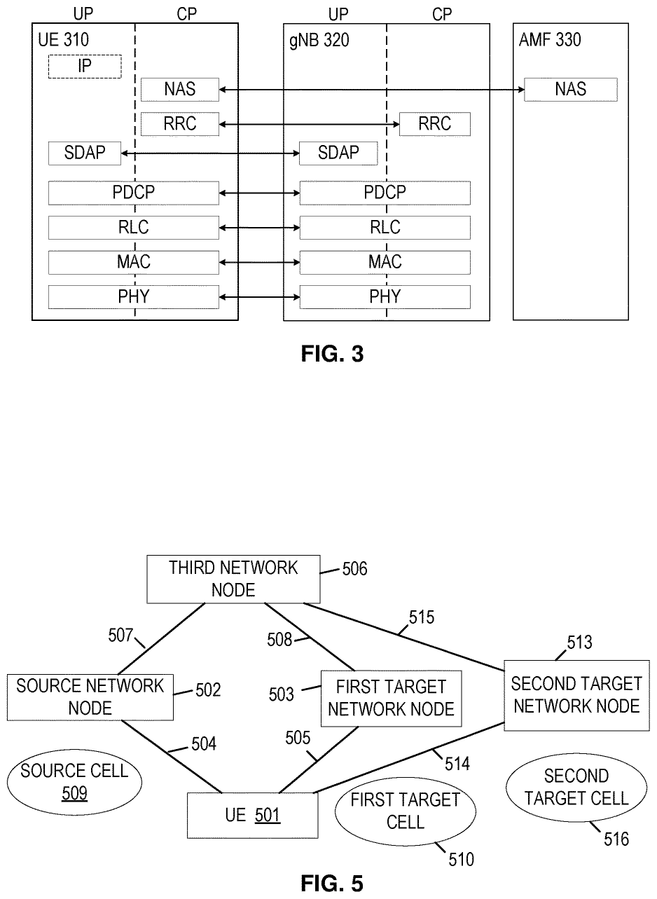

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On the CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

Seamless mobility is a key feature of 3GPP radio access technologies (RATs). In general, a network configures a UE to perform and report RRM measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

The network can configure a UE in RRC_CONNECTED state to perform and report RRM measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures. A radio link failure (RLF) procedure is typically triggered in the UE when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell (i.e., SpCell) and uses that information to decide whether the UE is in-sync (IS) or out-of-sync (OOS) with respect to that serving cell. In LTE, RLM is carried out by the UE measuring downlink reference signals (e.g., CRS) in RRC_CONNECTED state. If RLM (i.e., by L1/PHY) indicates number of consecutive OOS conditions to the UE RRC layer, then RRC starts a radio link failure (RLF) procedure and declares RLF after expiry of a timer (e.g., T310). The L1 RLM procedure is carried out by comparing the estimated CRS measurements to some target block error rates (BLERs), called Qout and Qin. In particular, Qout and Qin correspond to BLER of hypothetical PDCCH/PCIFCH transmissions from the serving cell, with exemplary values of 10% and 2%, respectively. In NR, the network can define the RS type (e.g., CSI-RS and/or SSB), exact resources to be monitored, and even the BLER target for IS and OOS indications.

In addition to providing coverage via “cells,” as in LTE, NR networks also provide coverage via “beams.” In general, a DL “beam” is a coverage area of a network-transmitted RS that may be measured or monitored by a UE. Such RS can include any of the following, alone or in combination: SS/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of RRC state, while other RS (e.g., CSI-RS, DMRS, PTRS) are associated with specific UEs that have a network connection, i.e., in RRC_CONNECTED state.

To support beam management, a UE can be configured with a CSI measurement configuration, which instructs the UE to monitor CSI-RS and to send various CSI reports to the RAN (e.g., NG-RAN). For example, the RAN indicates an explicit list of CSI resources to be monitored by the UE for each type of CSI report the UE is configured to send. Similar techniques can be used for beam management based on SSB transmitted by the network.

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signalled as a “delta-configuration” including only the differences from the UE's current configuration in the source cell.

To summarize, handover and other serving cell changes are triggered by layer 3 (L3, e.g., RRC) measurements and involves RRC signaling to change PCell and/or PSCell (e.g., when DC is configured), as well as release/add SCells (e.g., when CA is configured). Currently, L3 inter-cell mobility involves complete layer 2 (L2) and layer 1 (L1, i.e., PHY) resets, leading to longer latency, increased signaling overhead, and longer interruptions than for intra-cell beam switching. As discussed in the Background section above, the purpose of the LTM-triggered mobility procedures is to mitigate and/or completely avoid these problems in appropriate circumstances, by providing for a dynamic cell switching mechanism that does not require the execution of a layer 3 (RRC) reconfiguration procedure.

This text refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle is that the UE receives a lower layer signaling from the network indicating to the UE a change (or switch or activation) of its serving cell (e.g., change of PCell, from a source to a target PCell), wherein a lower layer signaling is a message/signaling of a lower layer protocol, which may be referred as a L1/L2 inter-cell mobility execution command or LTM cell switch command. The change of serving cell (e.g., change of PCell) may also lead to a change in Scell(s) for the same cell group e.g., in case the command triggers the UE to change to another cell group configuration of the same type (e.g., another MCG configuration). Before the UE receives the LTM cell switch command, the UE is configured by the network with one or more LTM candidate cell configurations (e.g., reception of an RRC Reconfiguration message, with at least one LTM candidate cell configuration). A LTM candidate cell configuration may include parameters in the information element (IE) CellGroupConfig for an LTM candidate cell and/or an embedded RRC Reconfiguration for an LTM candidate cell. The LTM cell switch command contains an LTM candidate configuration index, which identifies the target LTM candidate cell.

The term LTM cell switch procedure refers to the process of a UE switching (or changing) its cell from a source cell to a target cell (which may be called here an LTM candidate cell or a neighbor cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of the techniques described herein, switching to the LTM candidate cell comprises the UE considering that the LTM candidate cell becomes its new special cell (SpCell) e.g., PCell in case of LTM being configured for a Master Cell Group (MCG) and/or PSCell in case of LTM being configured for a Secondary Cell Group (SCG); or, changing its SpCell from the current PCell to an indicated LTM candidate cell. Note that while the terms “switch” or “change of cells” may be used to describe these procedures, this switch or change of cells may comprise a switch or change of an entire cell group configuration, which may include a change in the SpCell (e.g., change of PCell, or change of PSCell) and a change in SCells of the cell group (e.g. addition, modification and/or release of one or more SCells).

An LTM cell switch procedure may be triggered in the UE by reception of a LTM cell switch command, or alternatively, triggered by some other event, such as a condition, e.g., a triggering condition used for conditional configuration, such as conditional handover, being fulfilled, as a result of recovery from radio link failure or handover failure.

This text refers to an LTM candidate cell, which is a cell the UE is configured with when configured with L1/L2-triggered mobility. That is, an LTM candidate cell is a cell the UE can move to in a LTM cell switch procedure, upon reception of a LTM cell switch command. Such cells may also be called candidate cell(s), candidates, mobility candidates, non-serving cells, additional cells, target candidate cell, target candidate, etc. An LTM candidate cell is a cell the UE may perform measurements on (e.g., CSI measurements) so that the UE reports these measurements and network may take educated decision on which beam (e.g., TCI state) and/or cell the UE is to be switched to. An LTM candidate cell may be a candidate to be a target PCell or PSCell, or an SCell of a cell group (e.g., MCG SCell or a SCG SCell).

This document also refers to “at least one configured LTM candidate cell” and may indicate that the UE has received at least one LTM candidate cell configuration. This is also sometimes referred to as a configuration of a LTM candidate cell, which may be an RRC configuration, such as encapsulated in an RRC Reconfiguration message, that the UE receives when being configured with L1/L2-Triggered Mobility. A configuration of a LTM candidate cell comprises the configuration which the UE needs to start to operate accordingly when it performs an LTM cell switch procedure to that LTM candidate cell, e.g., upon reception of the LTM cell switch command directing the UE to perform an LTM cell switch procedure to that LTM candidate cell, which becomes the target cell and the current (new) SpCell, or an SCell in a serving frequency.

The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig, in the case of a Secondary Cell). An LTM candidate cell configuration may, for example, comprise one or more of: i) the PCell configuration and one or more SCell configuration(s) of a Master Cell Group (MCG); i) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably when referring to configuration of a LTM candidate cell.

An LTM candidate cell configuration is associated with an identifier which is used in the signaling when referring to a certain LTM candidate cell configuration, such as when the UE receives the LTM candidate cell configuration and when the UE receives an LTM cell switch command indicating the UE to perform a LTM cell switch procedure to that LTM candidate cell. This identifier is sometimes known as the LTM candidate cell configuration identity or LTM candidate configuration index (or similar).

Thus, in L1/L2-triggered mobility, the UE receives an LTM cell switch command containing an LTM candidate configuration index, and during the LTM cell switch procedure this index is used by the UE to identify an LTM candidate cell configuration. The UE then performs an RRC procedure, here referred to as an RRC LTM execution procedure, or sometime as LTM execution procedure or LTM execution RRC procedure, to apply and process the content of the LTM candidate cell configuration, which in turn, based on the included information elements (IEs) and fields inside the LTM candidate configuration, triggers execution of other RRC procedures related to those IEs and fields including configuration of lower layers (e.g. L1 and sometimes also RLC and/or MAC) according to those included IEs and fields.

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration index (sometimes also denoted candidate configuration ID). The UE may be configured with multiple LTM candidate cell configurations, e.g., so that a candidate distributed unit (DU) generates and sends to the central unit (CU) multiple configuration(s). The actual LTM candidate cell configuration the UE receives during the LTM configuration may be a delta signaling to be applied on top of a reference configuration, so that the actual configuration the UE is to use in the candidate cell upon LTM cell switch is the combination of the LTM candidate cell configuration and the reference configuration (e.g., separately signaled by the network to the UE).

The LTM cell switch command may also contain a beam indication. The term “beam” may correspond to a spatial direction in which a signal is transmitted (e.g., by a network node) or received (e.g., by the UE), or a spatial filter applied to a signal which is transmitted or received. Thus, transmitting signals on different beams could correspond to transmitting signals in different spatial directions. When the text refers to a “beam which is selected” it may refer to a beam index and/or a Reference Signal (RS) index or identifier, such as a Synchronization Signal block (SSB) index, or a CSI-RS resource identifier. Thus, selecting a beam may correspond to selecting an SSB, associated to an SSB index. Or, selecting a beam may correspond to selecting a CSI-RS, associated to a CSI-RS resource identifier.

The descriptions of various techniques herein refer to an “indication of applied LTM candidate.” This indication of applied LTM candidate may be an indication of the target cell, such as a cell identifier (e.g. PCI, CGI), an indication of an LTM candidate cell configuration, such as an LTM candidate cell configuration index or LTM candidate cell configuration identity, an indication of a beam, such as an SSB index or an CSI-RS resource identifier or an indication of an index that identify a particular RRC message previously sent by the network and received by the UE.

Many details of the procedures for L1/L2-based inter-cell mobility are still open in 3GPP. This applies also for the details of the LTM cell switch procedure.

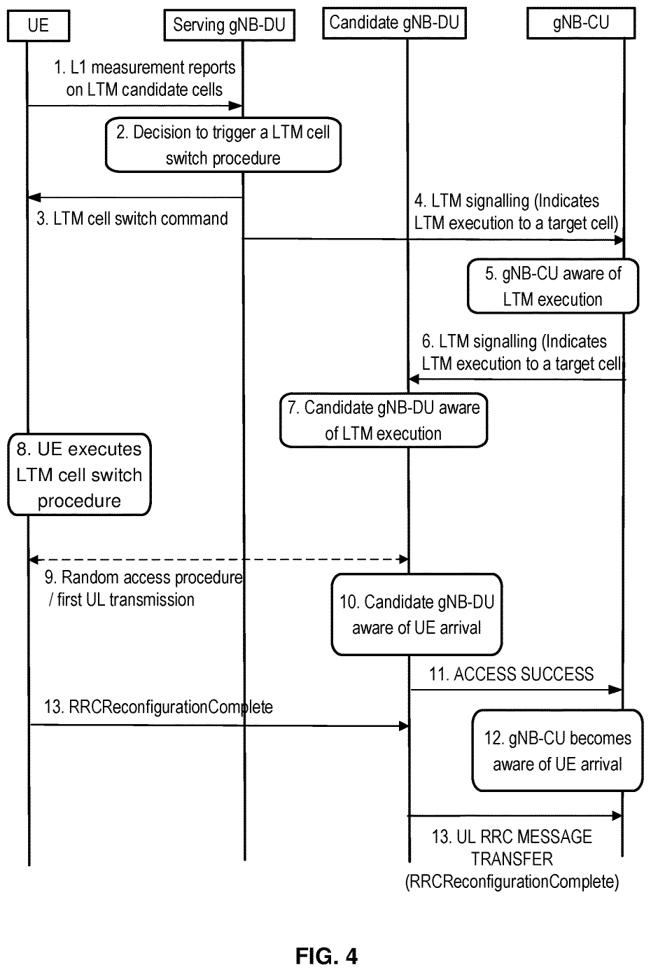

FIG. 4 shows an example of a possible signaling flow for the LTM cell switch procedure. This example starts with the execution of LTM cell switch procedure triggered by an L1 measurement report from the UE. Prior to this step, the UE has already been configured with LTM candidate cell configuration(s), each of them represented as individual RRCReconfiguration messages stored by the UE. When the UE executes the LTM cell switch procedure it transmits an RRCReconfigurationComplete message in the target cell. This message can be seen as the “response” message that confirms that the UE has applied the RRCReconfiguration message representing the LTM candidate cell configuration for the particular LTM candidate cell.

This example illustrates the inter-DU case but the signaling is also applicable for intra-DU, with the difference that the source gNB-DU and the candidate gNB-DU is a single gNB-DU.

In the agreed solution for how the UE should indicate its arrival in the target cell, the UE transmits an RRCReconfigurationComplete message after each LTM execution. This RRCReconfigurationComplete message is received and interpreted by the gNB-CU and the content is transparent for the candidate gNB-DU, since the message is encrypted. However, the candidate gNB-DU is made aware of the UE arrival at a previous point in time (in steps 9-10 of the signaling flow in FIG. 4), since, as per the RAN2 agreed solution, in RACH-based LTM, the candidate gNB-DU becomes aware of the UE's arrival based on the reception of preamble in CFRA and on the reception of Msg3/MsgA in CBRA. For RACH-less LTM, the candidate gNB-DU becomes aware of the UE's arrival based on reception of the first UL transmission from this UE (this first transmission may be the RRCReconfigurationComplete message for at least LTM for the Master Cell Group).

After an LTM cell switch, once the candidate gNB-DU becomes aware of the UE arrival in the target cell (or, in this context, the “first” target cell), the candidate gNB-DU (which from this point takes the role as the new serving gNB-DU) may trigger a subsequent LTM cell switch procedure to a second target cell (which, during what sometimes is known as “ping-pong” mobility, may be the previous source cell). In small cell scenarios and on high frequencies, cell switches may happen frequently and therefore a subsequent cell switch may be triggered shortly after the UE arrived in the first target cell.

However, if these LTM cell switch procedures are close to one another in time, the UE RRCReconfigurationComplete message transmitted by the UE in the first target cell after a first LTM cell switch may have not yet been successfully received by the gNB-CU at the time when the candidate gNB-DU triggers the subsequent LTM cell switch. For example, if the subsequent LTM cell switch is triggered when the UE has bad uplink radio conditions in the current serving cell(s), the transmitted RRCReconfigurationComplete triggered by the first LTM cell switch might become delayed even while the UE remains able to receive the LTM cell switch command for the subsequent LTM cell switch. In this case, if no RLC re-establishment was performed (e.g., at intra-DU LTM cell switch), the UE still keeps the RRCReconfigurationComplete message in the RLC or PDCP buffer, in order to retransmit the message as needed, since it may have not yet received a confirmation that the message was successfully delivered.

This may in turn mean that after the subsequent LTM cell switch procedure, the RRCReconfigurationComplete message that was transmitted in the first target cell, it may be retransmitted in the second target cell. When the third network node receives this RRCReconfigurationComplete message via the second target cell, it may have already received this message via the first target cell, due to race conditions in the network. Therefore, the third network node may incorrectly interpret this RRCReconfigurationComplete message received via the second target cell as an indication that the UE has arrived in the second target cell and has applied the corresponding LTM candidate cell configuration for the second target cell.

A similar case is when the UE has received an RRCReconfiguration message and started transmitting an RRCReconfigurationComplete message, and the network triggers an LTM cell switch procedure. In such cases, the RRCReconfigurationComplete message may not have been transmitted to the network, or at least the UE may not be aware, upon the reception of the LTM cell switch command, of whether or not this RRCReconfigurationComplete has been received by the network. In this case, this first RRCReconfigurationComplete message may be retransmitted in the target cell and therefore be received by the gNB-CU before a second RRCReconfigurationComplete message, which was sent due to the execution of the LTM cell switch procedure. In this case, the network will receive two RRCReconfigurationComplete messages in the target cell, and the network needs to correlate the received messages with the respective procedures that were triggered when the UE was in the source cell.

In RRC signaling, a solution used for associating responses with the requests is the sue of transaction identifiers, where a transaction ID is included in a request and the UE uses the same transaction ID in the transmitted response, as specified in 3GPP TS 38.331 section 5.1.2 as follows:
1> set the rrc-TransactionIdentifier in the response message, if included, to the same value as included in the message received from the network that triggered the response message;
   This makes it possible for the network to transmit multiple messages to the UE without awaiting response before transmitting the next and the network may still correlate responses with the requests.

When the UE transmitted an RRCReconfigurationComplete message at the arrival in the target cell at LTM cell switch execution, it will include a transaction identifier as well. However, the RRCReconfiguration message including a LTM candidate cell configuration was provided to the UE well in advance, which means that the transaction ID may typically be out of date by the time the UE transmits the message, since the transaction ID is only two bits according to the definition in 3GPP TS 38.331 section 6.3.4 as follows:

-- ASN1START
-- TAG-RRC-TRANSACTIONIDENTIFIER-START
RRC-TransactionIdentifier ::= INTEGER (0..3)
-- TAG-RRC-TRANSACTIONIDENTIFIER-STOP
-- ASN1STOP

This means that there needs to be a way for the network to determine, upon reception of an RRCReconfigurationComplete message from the UE that is configured for LTM, to associate this received RRCReconfigurationComplete message with a previously transmitted RRCReconfiguration message to the UE, including a RRCReconfiguration message used to configure a given LTM candidate cell configuration.

For conditional PSCell change (CPC) and conditional PSCell addition (CPA), the UE indicates the selected cell in the RRCReconfigurationComplete message as specified in 3GPP TS 38.3312 section 5.3.5.3 as follows:
2> if the RRCReconfiguration message includes the mrdc-SecondaryCellGroupConfig with mrdc-SecondaryCellGroup set to nr-SCG:
   3> include in the nr-SCG-Response the SCG RRCReconfigurationComplete message;
   3> if the RRCReconfiguration message is applied due to conditional reconfiguration execution and the RRCReconfiguration message does not include the reconfigurationWithSync in the masterCellGroup:
      4> include in the selectedCondRRCReconfig the condReconfigId for the selected cell of conditional reconfiguration execution;

However, this solution can only be used for CPC/CPA in the case specified above and therefore it is not applicable for L1/L2-triggered mobility (LTM).

The techniques described below address these problems by having the UE indicate the applied LTM candidate configuration at LTM cell switch. As will be described in further detail below, an example of a method carried out by the UE according to these techniques comprises receiving, from a network node, at least one LTM candidate cell configuration, executing an LTM cell switch procedure by applying the received indicated LTM candidate cell configuration, and transmitting, to a network node, such as a first target network node, a second target network node, or a third network node, an LTM cell switch complete message that includes an indication of applied LTM candidate. In various embodiments, the indication of applied LTM candidate may be an indication of the target cell, an indication of an LTM candidate cell configuration, an indication of a beam, or an identifier of a procedure, transaction or message instance. Corresponding and complementary techniques carried out by other nodes involved in the LTM cell switch procedure are also detailed herein. One or several of these techniques may be used to enable the network to know which LTM candidate cell configuration the UE has applied after execution of an LTM cell switch, in particular when the UE performs a first LTM cell switch shortly followed by a second, subsequent, LTM cell switch.

FIG. 5 illustrates a system structure including the entities involved in the techniques described herein. The User Equipment (UE) 501 is a wireless terminal, such as a cellular smartphone, sometimes connected to the source network node 502 over a wireless interface 504 and sometimes connected to a first target network node 503, to which the UE 501 is connected over a wireless interface 505. In some cases, the UE 501 is connected to a second target network node 513 over a wireless interface 514.

In the context of a mobility procedure, such as a LTM cell switch procedure, for the UE, the source network node 502, sometimes also referred to as the serving network node, controls a source cell 509 (sometimes called serving cell or Special Cell (SpCell). The first target network node 503 controls a first target cell 510 (sometimes called target cell, neighbour cell, candidate cell or LTM candidate cell). In the context of a mobility procedure for the UE, the second target network node 513 controls a second target cell 516.

Each of source network node 502, the first target network node 503 and the second target network node 513 may be a base station, such as a gNB, or, in the case of a distributed CU/DU RAN architecture, a distributed unit, sometimes known as either gNB-DU or DU. These nodes were described above, in the context of FIGS. 1 and 2. Hence the source network node 502 may correspond to a source DU (S-DU), sometimes also known as serving DU, the first target network node 503 may correspond to a target DU (T-DU), and the second target network node 513 may correspond to a second target DU. A first or second target DU is sometimes called a neighbor DU or candidate DU (C-DU).

The source network node 502, the first target network node 503 and the second target network node 513 are all connected to a third network node 506, sometime also referred to as serving network node. In FIG. 5, these connections are via interfaces 507, 508, and 515, respectively. The source network node and either of the first or second target network nodes may be the same network node. In some scenarios the source network node and either of the first or second target network nodes may be connected to different third network nodes 506.

Further, the third network node 506 may, e.g. in case of a distributed CU/DU RAN architecture, be a central unit (CU), sometimes referred to as the serving CU, known as either a gNB-CU, CU, gNB-CU-CP or gNB-CU-UP, or a core network node such as an User Plane Function (UPF) or an Access and Mobility management Function (AMF).

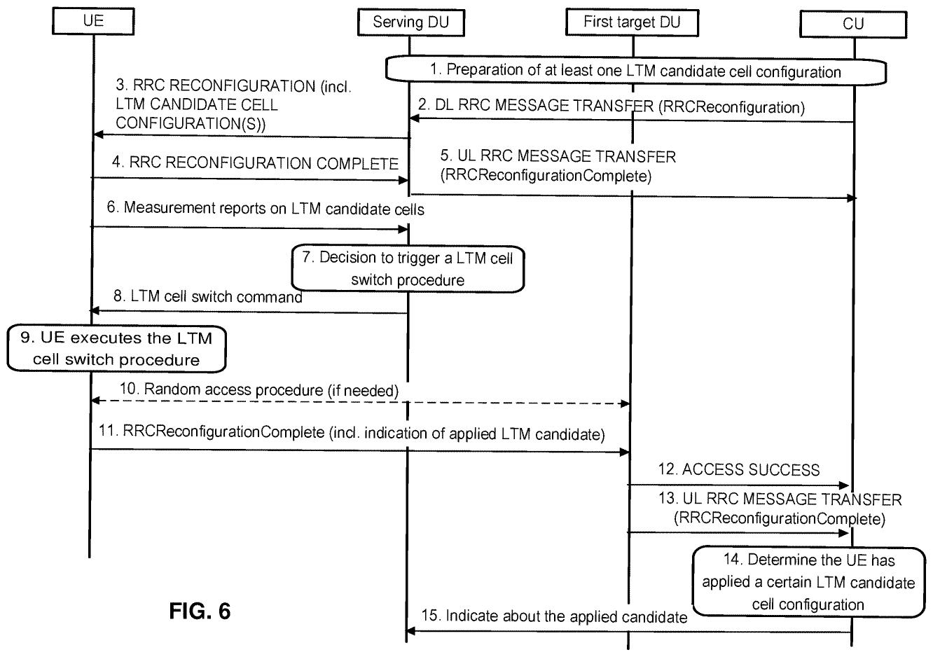

FIG. 6 is a message sequence chart illustrating signaling and steps according to several embodiments of the techniques described herein for improving LTM. In the scenario shown here, only one LTM cell switch procedure is triggered. The main steps and signals illustrated in this figure are as follows:
Step 1. The network prepares at least one LTM candidate cell configuration. In this example, a first target cell controlled by the first target CU is included in one LTM candidate cell configuration.
Step 2. The CU transmits, to the Serving DU, an DL RRC MESSAGE TRANSFER including an RRCReconfiguration message, which includes the at least one LTM candidate cell configuration.
Step 3. The Serving DU transmits, to the UE, the RRCReconfiguration message, containing the at least one LTM candidate cell configuration.
Step 4. The UE stores the received LTM candidate cell configuration and responds with an RRCReconfigurationComplete message to the Serving DU.
Step 5. The Serving DU transmits, to the CU, an UL RRC MESSAGE TRANSFER containing the received RRCReconfigurationComplete message.
Step 6. The UE measures on the configured LTM candidate cells and transmits measurement reports, such as lower-layer measurement reports, such as CSI measurements, to the Serving DU.
Step 7. The Serving DU decides to trigger an LTM cell switch procedure to a target cell, in this example, a first target cell controlled by the first target DU.
Step 8. The Serving DU transmits an LTM cell switch command to the UE to trigger the LTM cell switch procedure. The LTM cell switch command contains an indication of the LTM candidate cell configuration for the first target cell.
Step 9. In response to the received an LTM cell switch command, the UE executes the LTM cell switch procedure, including applying the indicated LTM candidate cell configuration and switching to the first target cell.
Steps 10-11. The UE transmits an LTM cell switch complete message, such as an RRCReconfigurationComplete message, in the first target cell to the first target DU, after a potential random access procedure, according to the applied LTM candidate cell configuration. The LTM cell switch complete message contains an indication of applied LTM candidate, such as an indication of the LTM candidate cell configuration for the first target cell.
Steps 12-13. When detecting reception of uplink data or signalling from the UE, the first target DU transmits, to the CU, an ACCESS SUCCESS indicating the UE arrival in the first target cell. The first target DU also forwards, to the CU, the received LTM cell switch complete message, such as an RRCReconfigurationComplete message, carried in an UL RRC MESSAGE TRANSFER message.
Step 14. Upon reception of the LTM cell switch complete message, such as an RRCReconfigurationComplete message, the CU uses the indication of applied
LTM candidate to determine that the UE has applied a certain LTM candidate cell configuration, in this case the LTM candidate cell configuration for the first target cell.
Step 15. The CU transmits a message to the serving DU to inform about the applied LTM candidate, containing the indication of the LTM candidate cell configuration for the first target cell. This message can be a new message for a class 2 procedure, for example, or the UE Context Modification procedure can be used.

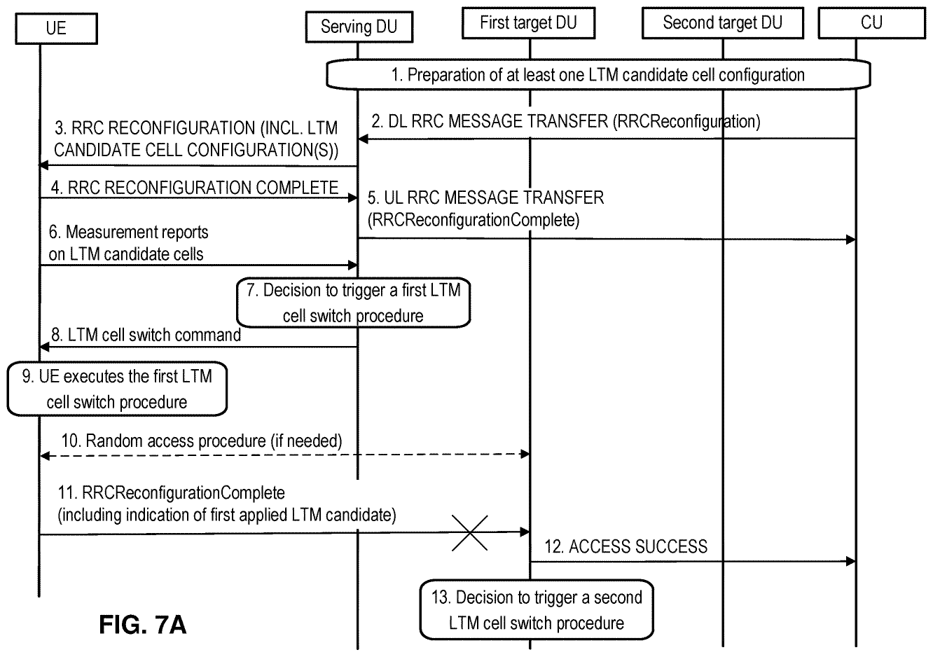

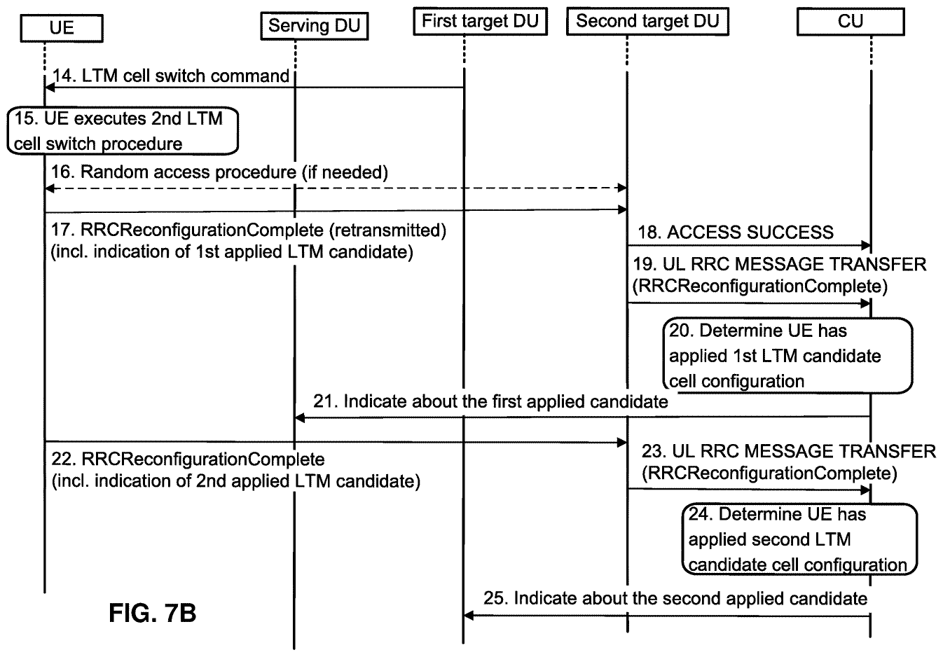

FIG. 7A and FIG. 7B provide another message sequence chart illustrating signaling and steps according to several embodiments of the techniques described herein for improving LTM. In the scenario shown here, two consecutive LTM cell switch procedures are triggered. Thus, the sequence shown in FIG. 7A and FIG. 7B departs from that of FIG. 6 starting at Step 11. The main steps and signals illustrated in this figure are as follows:
Step 1. The network prepares at least one LTM candidate cell configuration. In this example, a first target cell controlled by the first target CU is included in one LTM candidate cell configuration.
Step 2. The CU transmits, to the Serving DU, an DL RRC MESSAGE TRANSFER including an RRCReconfiguration message, which includes the at least one LTM candidate cell configuration.
Step 3. The Serving DU transmits, to the UE, the RRCReconfiguration message, containing the at least one LTM candidate cell configuration.
Step 4. The UE stores the received LTM candidate cell configuration and responds with an RRCReconfigurationComplete message to the Serving DU.
Step 5. The Serving DU transmits, to the CU, an UL RRC MESSAGE TRANSFER containing the received RRCReconfigurationComplete message.
Step 6. The UE measures on the configured LTM candidate cells and transmits measurement reports, such as lower-layer measurement reports, such as CSI measurements, to the Serving DU.
Step 7. The Serving DU decides to trigger a first LTM cell switch procedure to a target cell, in this example, a first target cell controlled by the first target DU.
Step 8. The Serving DU transmits an LTM cell switch command to the UE to trigger the first LTM cell switch procedure. The LTM cell switch command contains an indication of the LTM candidate cell configuration for the first target cell
Step 9. As response to the received LTM cell switch command, the UE executes the first LTM cell switch procedure including applying the indicated LTM candidate cell configuration and switching to the first target cell.
Steps 10-11. The UE transmits a first LTM cell switch complete message, such as a first RRCReconfigurationComplete message, in the first target cell to the first target DU, after a potential random access procedure, according to the applied LTM candidate cell configuration. The first LTM cell switch complete message contains an indication of applied LTM candidate, such as an indication of the LTM candidate cell configuration for the first target cell. However, in this scenario, the first target DU may either have not yet successfully received the LTM cell switch complete message, e.g., due to bad signal conditions, or it might receive the uplink signaling from the UE but not be able to see the content of the uplink signalling or data (including the RRCReconfigurationComplete) when it is encrypted. In this latter case, it sees only that the UE has transmitted something on a signalling radio bearer, in this case, and forwards that data to the CU when it has successfully concatenated all segments (in HARQ or RLC) of that message. But in this case it has not received all segments so it cannot yet forward the full message
Step 12. In this example, the first target DU detects reception of uplink data or signalling from the UE, and transmits, to the CU, an ACCESS SUCCESS indicating the UE arrival in the first target cell. Note that this may be the case even the first target DU is unable to read the content of the signaling or data (including the RRCReconfigurationComplete), but the fact that the first target DU has received something from the UE is enough for the first target DU to become aware of the arrival of the UE and thus trigger the ACCESS SUCCESS message shown in the figure.
Step 13. The first target DU decides to trigger a second LTM cell switch procedure to a second target cell controlled by the second target DU.
Step 14. (Shown at the top of FIG. 7B) The first target DU transmits an LTM cell switch command to the UE to trigger the second LTM cell switch procedure. The LTM cell switch command contains an indication of the LTM candidate cell configuration for the second target cell. In this example, and at this point, the RRCReconfigurationComplete message transmitted by the UE in the first target cell has not yet been successfully received by the first target DU.
Step 15. As response to the received LTM cell switch command, the UE executes the second LTM cell switch procedure including applying the indicated LTM candidate cell configuration and switching to the second target cell.
Steps 16-17. As the UE has not yet received a confirmation that the first LTM cell switch complete message transmitted in step 11 was received by the network, the UE now retransmits this message in the second target cell to the second target DU, after a potential random access procedure. The LTM cell switch complete message contains an indication of applied LTM candidate, such as an indication of the LTM candidate cell configuration for the first target cell.
Steps 18-19. When detecting reception of uplink data or signalling from the UE, the second target DU transmits, to the CU, an ACCESS SUCCESS indicating the UE arrival in the second target cell. The second target DU also forwards, to the CU, the received first LTM cell switch complete message, such as an RRCReconfigurationComplete message carried in an UL RRC MESSAGE TRANSFER message.
Step 20. Upon reception of the first LTM cell switch complete message, such as an RRCReconfigurationComplete message, the CU uses the indication of applied LTM candidate to determine that the UE has applied a certain LTM candidate cell configuration, in this case the LTM candidate cell configuration for the first target cell.
Step 21. The CU transmits a message to the serving DU to inform about the applied LTM candidate, containing the indication of the LTM candidate cell configuration for the first target cell. This message can be a new message for a class 2 procedure or the UE Context Modification procedure can be used.
Steps 22-23. The UE now transmits a second LTM cell switch complete message, such as an RRCReconfigurationComplete message, in the second target cell to the second target DU. The second LTM cell switch complete message contains an indication of applied LTM candidate, such as an indication of the LTM candidate cell configuration for the second target cell. The second target DU forwards this message to the CU in an UL RRC MESSAGE TRANSFER message.
Step 24. Upon reception of the second LTM cell switch complete message, such as an RRCReconfigurationComplete message, the CU uses the indication of applied LTM candidate to determine that the UE has applied a certain LTM candidate cell configuration, in this case the LTM candidate cell configuration for the second target cell.
Step 25. The CU transmits a message to the first target DU to inform about the applied LTM candidate, containing the indication of the LTM candidate cell configuration for the second target cell. This message can be a new message for a class 2 procedure or the UE Context Modification procedure can be used.

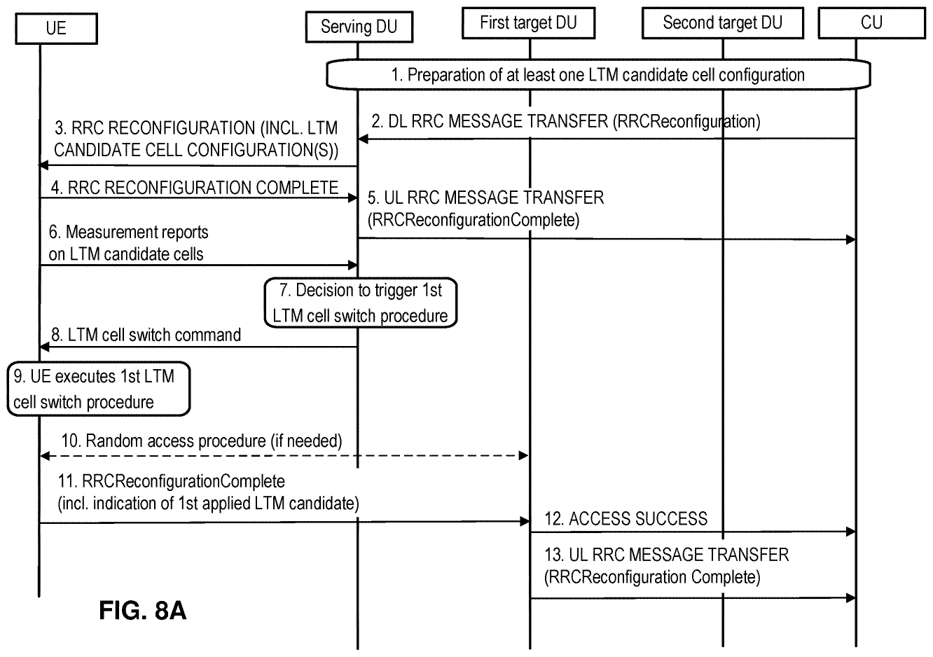

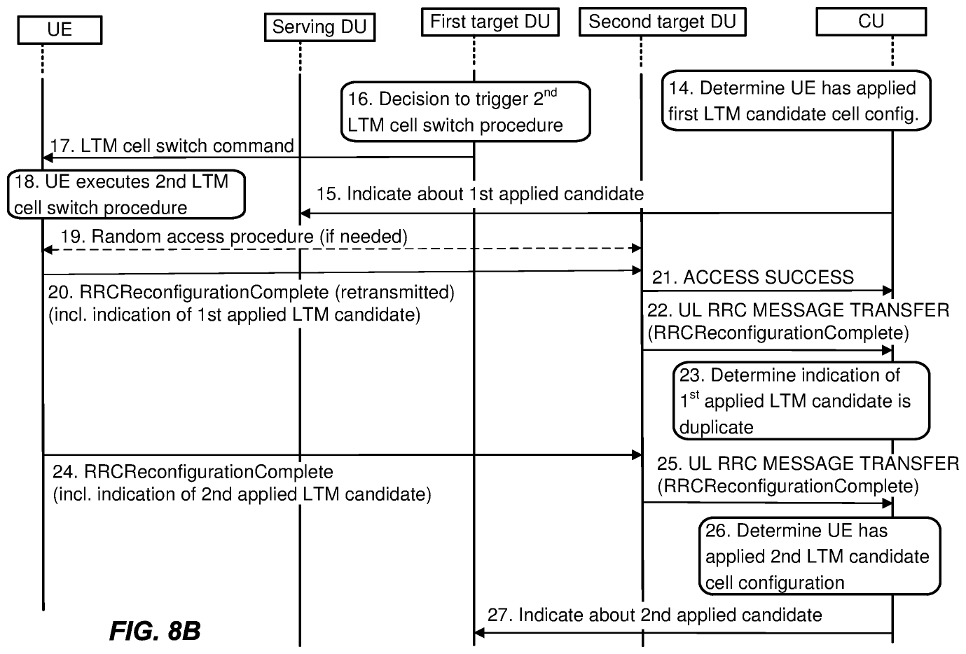

FIG. 8A and FIG. 8B together provide yet another message sequence chart illustrating signaling and steps according to several embodiments of the techniques described herein for improving LTM. In the scenario shown here, two consecutive LTM cell switch procedures are triggered. The sequence shown in FIG. 8A and FIG. 8B departs from that of FIG. 6 starting at Step 12. The remaining steps and signals illustrated in this figure are as follows:
Steps 12-13. When detecting reception of uplink data or signalling from the UE, the first target DU transmits, to the CU, an ACCESS SUCCESS indicating the UE arrival in the first target cell. The first target DU also forwards, to the CU, the received LTM cell switch complete message, such as an RRCReconfigurationComplete message, carried in an UL RRC MESSAGE TRANSFER message. Note that even if this LTM cell switch complete message was received by the first target DU, in this example the acknowledgement on lower layers sent to the UE for this message was lost so the UE still needs to assume that the message was not yet received by the network.
Step 14. (Shown at the top right-hand side of FIG. 8B.) Upon reception of the LTM cell switch complete message, such as an RRCReconfigurationComplete message, the CU uses the indication of applied LTM candidate to determine that the UE has applied a certain LTM candidate cell configuration, in this case the LTM candidate cell configuration for the first target cell.
Step 15. The CU transmits a message to the serving DU to inform about the applied LTM candidate, containing the indication of the LTM candidate cell configuration for the first target cell. This message can be a new message for a class 2 procedure or the UE Context Modification procedure can be used.
Steps 16-22. Same as the steps 13-19 in FIG. 6.
Step 23. Upon reception of the first LTM cell switch complete message, such as an RRCReconfigurationComplete message, the CU uses the indication of applied LTM candidate to determine that the UE has applied a certain LTM candidate cell configuration, in this case the LTM candidate cell configuration for the first target cell. However, the CU determines that this indication is a duplicate of the indication previously received in step 13.
Steps 24-27. Same as the steps 22-25 in FIG. 6.

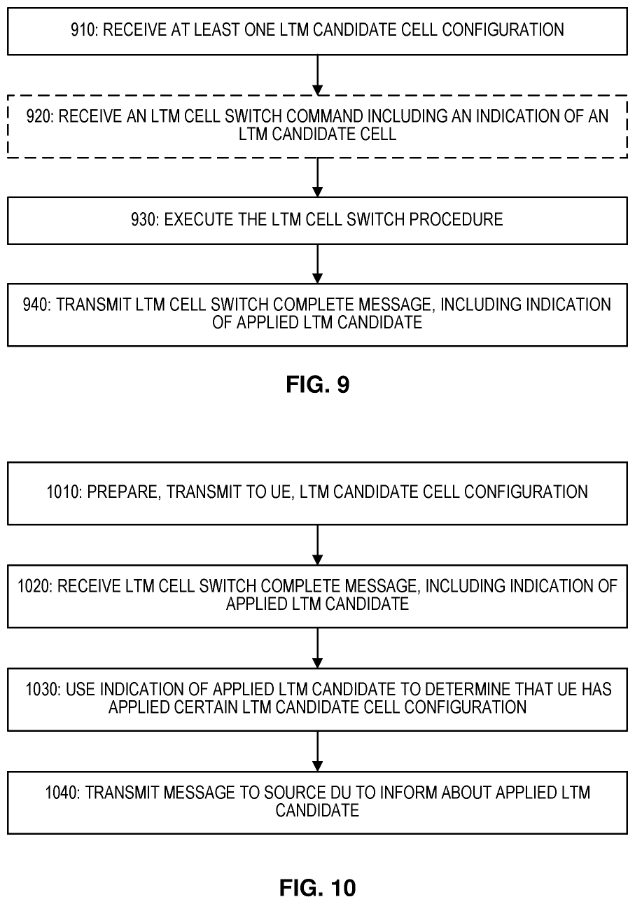

FIG. 9 is a process flow diagram illustrating steps of an example method, according to the techniques described herein, as implemented by the UE. Steps performed by the UE in this example are as follows:
Step 910. The UE receives at least one LTM candidate cell configuration from the network.
Step 920. The UE receives an LTM cell switch command to trigger an LTM cell switch procedure. The LTM cell switch command contains an indication of the LTM candidate cell configuration for a first target cell. Note that as discussed elsewhere herein there are also be cases when a UE executes an LTM cell switch that is not triggered by the reception of an LTM cell switch command, e.g., in response to a certain predetermined condition being met or when the LTM cell switch procedure is caused by failure recovery. Box 920 in FIG. 9 is illustrated with a dashed outline to indicate that it need not be present in every instance or embodiment of the illustrated method.
Step 930. As response to the LTM cell switch command, the UE executes the LTM cell switch procedure, including applying the indicated LTM candidate cell configuration.
Step 940. The UE transmits an LTM cell switch complete message, such as an RRCReconfigurationComplete message, in the first target cell according to the applied LTM candidate cell configuration. The LTM cell switch complete message contains an indication of applied LTM candidate, such as an indication of the LTM candidate cell configuration for the first target cell.

Thus, embodiments of the techniques described herein include methods in a wireless device, or UE, operating in a wireless network, where an example method includes receiving, from a network node in the wireless network, an LTM candidate cell configuration, and executing an LTM cell switch procedure by applying the received indicated LTM candidate cell configuration. This example method further comprises transmitting, to a network node, an LTM cell switch complete message that includes an indication of applied LTM candidate for the LTM cell switch procedure. This LTM cell switch complete message may be an RRCReconfigurationComplete message, for example, with this message including the indication described herein.

This indication of the applied LTM candidate may be one of any of the following, for example: an indication of a cell, such as a cell identifier (e.g., PCI, CGI); an indication of an LTM candidate cell configuration, such as an LTM candidate cell configuration index or LTM candidate cell configuration identity; an indication of a beam, such as an SSB index or an CSI-RS resource identifier; an indication of a RRC message for LTM, such as a message identifier for an RRC message that has been used to provide an LTM candidate cell configuration; and an indication that the LTM cell switch complete message is for LTM. The indication of the applied LTM candidate is thus an identifier or other indication that allows a node in the network match the cell switch complete message to the LTM candidate cell configuration and/or the cell switch procedure. This allows the network to resolve the ambiguous scenarios discussed above, arising from certain situations where multiple LTM cell switch procedures are performed in a row.

In view of those scenarios, e.g., as illustrated in FIGS. 7 and 8, as well as a “normal” scenario, as illustrated in FIG. 6, it will be appreciated that the LTM cell switch complete message may be transmitted to any of several network nodes. In some instances, it is transmitted to a first target network node, i.e., the network node controlling the target cell for the LTM cell switch procedure. An example of this is illustrated in FIG. 6. In other instances, the LTM cell switch procedure to the first target cell is followed by a second LTM cell switch procedure to a second target cell, controlled by a second target network node, in which case an LTM cell switch complete message corresponding to the first LTM cell switch procedure may be transmitted to the second target network node, while including an indication of the applied LTM candidate that corresponds to the first LTM cell switch procedure. Examples of this are shown in FIGS. 7 and 8. In these instances, the UE may subsequently transmit a second LTM cell switch complete message, e.g., to the second target network node, with an indication of an applied LTM candidate corresponding to the second LTM cell switch procedure. Again, examples of this are shown in FIGS. 7 and 8. In various other instances, the LTM cell switch complete message that includes the indication of the applied LTM candidate for the first LTM cell switch procedure may be transmitted to a third network node, such as a central unit (CU) controlling the first network node or the second network node, in various scenarios like those discussed above.

In some of the instances or embodiments described above, the execution of the LTM cell switch procedure may be triggered by receipt of an LTM cell switch command. (This is shown at block 920, as an example.) This may be received from a source network node, for example, such as a serving distributed unit (DU) (see FIGS. 6-8), triggering the LTM cell switch procedure to a first target cell, controlled by a first target network node, e.g., as discussed above. Note that this first target network node may be the same network node controlling the source cell, in some instances, i.e., the source network node, or the first target network node may be a different network node. In some instances, e.g., as shown in FIGS. 7 and 8, the execution of the LTM cell switch procedure to the first target cell may be followed by receipt of a second LTM cell switch command, triggering a second LTM cell switch procedure to a second target cell, controlled by a second target network, where this second LTM cell switch command is sent by the first target network node.

FIG. 10 is a process flow diagram illustrating steps of an example method performed by a network node, e.g., the third network node 506 of FIG. 5, which may be, for example, a Central Unit (CU) of a gNB. Steps performed by the network node in this example include:
Step 1010. The CU prepares and transmits, to the UE, at least one LTM candidate cell configuration.
Step 1020. The CU receives an LTM cell switch complete message that indicates the UE has executed an LTM cell switch procedure, including an indication of applied LTM candidate.
Step 1030. The CU uses the indication of applied LTM candidate to determine that the UE has applied a certain LTM candidate cell configuration, in this case the LTM candidate cell configuration for the first target cell.
Step 1040. The CU transmits a message to the source DU to inform about the applied LTM candidate (indication of applied LTM candidate), containing the indication of the LTM candidate cell configuration for the first target cell.

It will be understood, e.g., from FIGS. 6-8, that there are corresponding and complementary methods carried out at other network nodes, including the first target network node (e.g., a first target gNB or DUO), and the second target network node. An example method carried out by a first target network node for handling an LTM cell switch procedure comprises receiving, from a UE, an LTM cell switch complete message that includes an indication of applied LTM candidate. As discussed above, the LTM cell switch complete message may be an RRCReconfigurationComplete message, for example. Likewise, the indication of applied LTM candidate may be any of the various indicators or identifiers described above in connection with FIG. 9, for example. This example method may further comprise determining that the execution for an LTM cell switch procedure for a UE was completed, based on the LTM cell switch complete message, e.g., based on the indication of applied LTM candidate.

In various embodiments and/or instances, the first target network node determines that the UE has performed one of the following, based on the LTM cell switch complete message: switching to a certain cell, controlled by the first target network node or a second target network node; applying a certain LTM candidate cell configuration, controlled by the first target network node, a second target network node, or a third network node; switching to a certain beam, controlled by the first target network node or a second target network node; executing a certain procedure, transaction, or message instance, such as a certain RRC procedure or a MAC CE instance. In some embodiments or instances, the first target network transmits, to a source network node for the LTM cell switch procedure, or to a second target network node (e.g., the target of a second LTM cell switch procedure for the UE), or to a third network node (e.g., a CU), an indication that the execution of the LTM cell switch procedure for the UE was completed. This indication that the execution was completed might be included in an UL RRC MESSAGE TRANSFER message, for example, or it might be an ACCESS SUCCESS message or a UE CONTEXT MODIFICATION REQUIRED message, or a new type of F1AP message.

In some embodiments or instances, this first target network node may receive, from a second target network node or a third network node, an indication that the execution of an LTM cell switch procedure for the UE was completed. This indication, which might be in the form of a UE CONTEXT MODIFICATION REQUEST message, may relate to a second LTM cell switch procedure executed by the UE and triggered by the first target network node.

Example methods for a second target network node (such as a second target gNB, a second target DU), for handling an LTM cell switch procedure for a UE, may comprise receiving, from the UE, an LTM cell switch complete message including an indication of applied LTM candidate. This indication of applied LTM candidate, which may be any of the indicators or identifiers discussed above, may relate to an earlier LTM cell switch procedure by the UE to a target network node other than the second target network node, for example. The method carried out by the second target network node may further comprise determining, based on the message, e.g., based on the indication that the execution of an LTM cell switch procedure for a UE was completed. This determination by the second target network node may comprise determining that the UE has performed one of the following, in various instances or embodiments: switching to a certain cell, controlled by the second target network node or by a first target network node; applying a certain LTM candidate cell configuration, controlled by the second target network node, by a first target network node or by a third network node; switching to a certain beam, controlled by the second target network node or by a first target network node; and executing a certain procedure, transaction, or message instance, such as a certain RRC procedure or a MAC CE instance.

In some embodiments or instances, the second target network node may transmit, e.g., to a source network node, a first target network node, or a third network node, an indication that the execution of an LTM cell switch procedure for a UE was completed. This indication may relate to an earlier LTM cell switch procedure targeted to the first target network node, for example, as determined from the indication in the LTM cell switch complete message. This indication may be an UL RRC MESSAGE TRANSFER message containing an LTM cell switch complete message, an ACCESS SUCCESS message, a UE CONTEXT MODIFICATION REQUIRED message, or a new type of F1AP message, in various embodiments and/or instances.

In some embodiments or instances, the second target network node may receive, from a first target network node or a third network node, an indication that the execution of an LTM cell switch procedure for a UE was completed. This indication may be a UE CONTEXT MODIFICATION REQUEST message, for example.

Corresponding methods at a third network node, or serving network node, such as a serving central unit (CU) or gNB, for handling LTM cell switch procedures for a UE, comprise the steps of transmitting, to the UE, at least one LTM candidate cell configuration and receiving, from the UE, an LTM cell switch complete message, where the LTM cell switch complete message includes an indication of applied LTM candidate, in response to sending an LTM cell switch command to initiate an LTM cell switch procedure.

In various embodiments, when the third network node transmits the at least one LTM candidate cell configuration to the UE, it includes with or in the message(s) that carry(ies) the LTM candidate cell configuration, one or more of the following: an identifier of a procedure, transaction, or message instance, such as an RRC transaction identifier that is only used when transmitting an LTM candidate cell configuration; an identifier of a procedure, transaction, or message instance, such as an RRC transaction identifier that is an extension of an existing identifier of a procedure, transaction, or message instance, such as an RRC transaction identifier; and/or an indication that the UE, when sending an LTM cell switch complete message should also include in the RRC message that carries the an LTM cell switch complete message an indication that this an LTM cell switch complete message is for LTM.

As discussed above, the indication of applied LTM candidate received from the UE may be an indication of a cell, such as a cell identifier (e.g., PCI, CGI), an indication of an LTM candidate cell configuration, such as an LTM candidate cell configuration index or LTM candidate cell configuration identity, an indication of a beam, such as an SSB index or an CSI-RS resource identifier, an identifier of a procedure, transaction, or message instance, such as an RRC transaction identifier, and/or an indication that the LTM cell switch complete message is for LTM.

In some embodiments or instances, the third network node determines that the execution of an LTM cell switch procedure for a UE was completed; the indication of applied LTM candidate may be used for the determination, in some instances or embodiments. The third network node may determine that the UE has performed one of: switching to a certain cell, controlled by a first target network node or by a second target network node; applying a certain LTM candidate cell configuration, controlled by the third network node, a first target network node or by second target network node; switching to a certain beam, a first target network node or by a second target network node; or executing a certain procedure, transaction, or message instance, such as a certain RRC procedure or a MAC CE instance

In some embodiments or instances, the third network node transmits, to a first target network node or a second target network node, an indication that the execution of an LTM cell switch procedure for the UE was completed. This may be a UE CONTEXT MODIFICATION REQUEST message, for example.

In other embodiments or instances, the third network node may receive, from a first target network node or a second target network node, an indication that the execution of an LTM cell switch procedure for the UE was completed. This might be, for instance, a UL RRC MESSAGE TRANSFER message containing an LTM cell switch complete message, or an ACCESS SUCCESS message, or a UE CONTEXT MODIFICATION REQUIRED message, or a new type of F1AP message.

In some embodiments or instances, the third network node receives a first LTM cell switch complete message following the execution of a first LTM cell switch procedure and a second LTM cell switch complete message following the execution of a second LTM cell switch procedure. In some of these embodiments or instances, the third network node may determine that the first and second LTM cell switch complete messages are duplicates—this determination may be based on the indications of applied LTM candidate in the first and second LTM cell switch complete messages, such as they include the same indication of applied LTM candidate.

Similarly, in some embodiments or instances the third network node may receive a first LTM cell switch complete message following the execution of a first LTM cell switch procedure and may further receive second and third LTM cell switch complete messages following the execution of a second LTM cell switch procedure. The third network node in these embodiments may determine that two of the first, second, and third LTM cell switch complete message are duplicates, based on the indications of applied LTM candidate in two of the first, second or third LTM cell switch complete messages, such as they include the same indication of applied LTM candidate.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

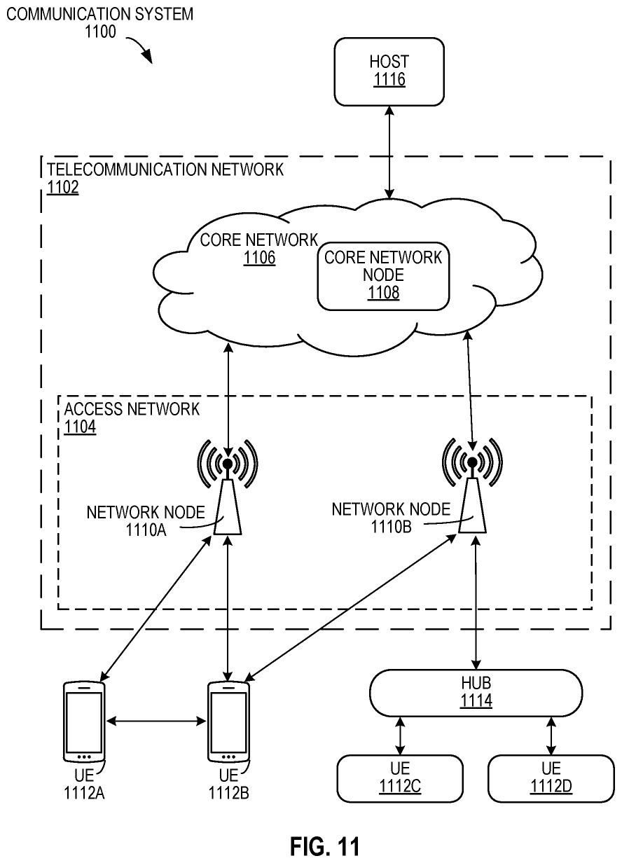

FIG. 11 shows an example of a communication system 1100 in accordance with some embodiments. In this example, the communication system 1100 includes a telecommunication network 1102 that includes an access network 1104 (e.g., RAN) and a core network 1106, which includes one or more core network nodes 1108. The access network 1104 includes one or more access network nodes, such as network nodes 1110a-b (one or more of which may be generally referred to as network nodes 1110), or any other similar 3GPP access node or non-3GPP access point. The network nodes 1110 facilitate direct or indirect connection of UEs, such as by connecting UEs 1112a-d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

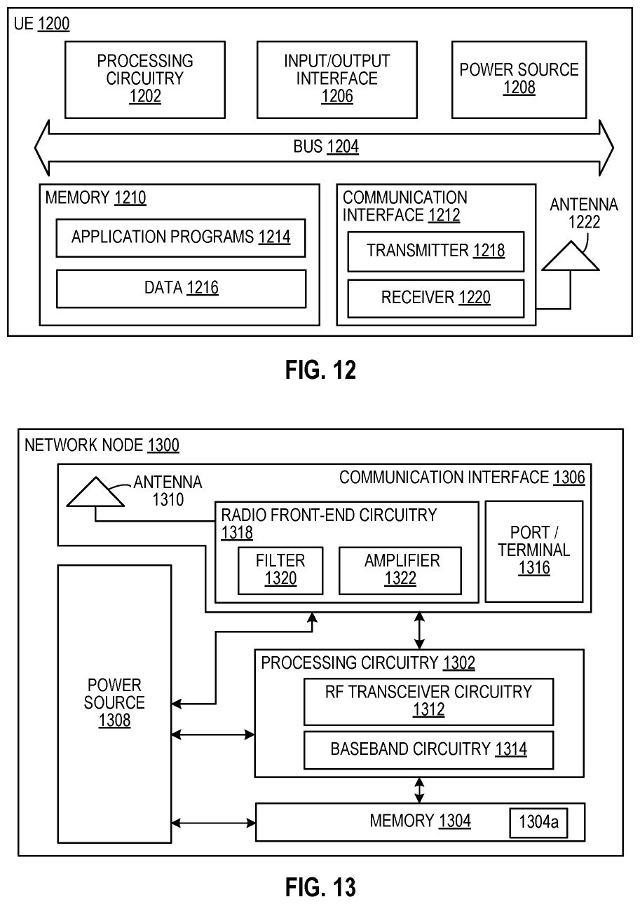

FIG. 12 shows a UE 1200 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

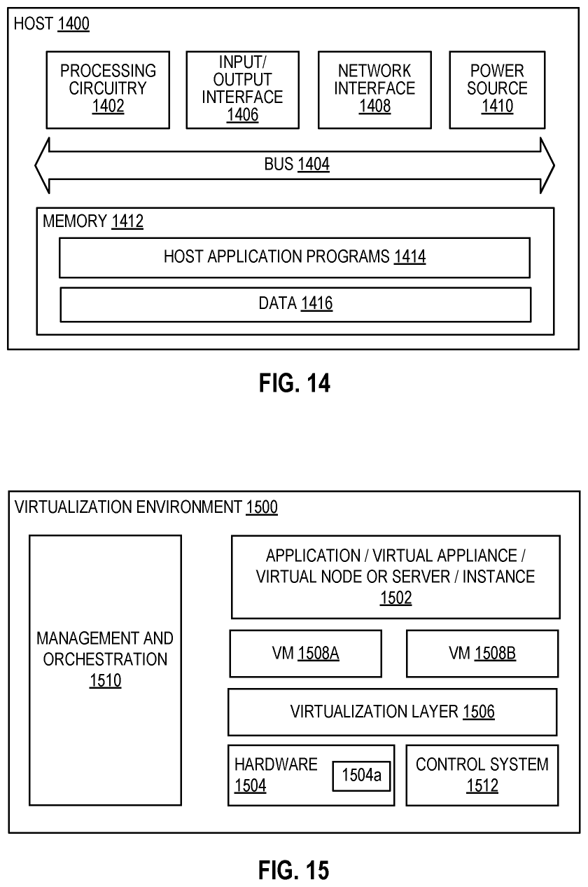

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a-b (one or more of which may be generally referred to as VMs 1508), and/or perform any of the functions, features and/or benefits described in relation with some embodiments described herein. The virtualization layer 1506 may present a virtual operating platform that appears like networking hardware to VMs 1508.

VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each VM 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

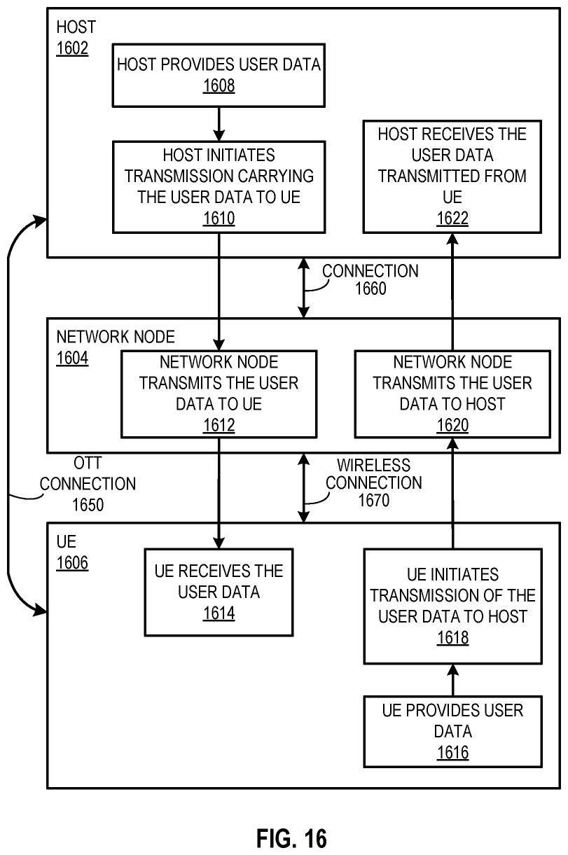

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments can prevent an illegitimate RAN node from success through repeated attempts to “guess” a security token associated with an LTM cell switch command for a UE. Embodiments can also prevent a UE from responding to a correct “guess” after repeated attempts. In this manner, embodiments can facilitate predictable UE behavior in LTM execution and prevent overload conditions in cells served by legitimate RAN nodes due to actions by illegitimate RAN nodes. When UEs and RAN nodes improved in this manner are used to deliver OTT services, they increase the value of the OTT services to end users and service provider(s).

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method, for a user equipment, UE, for L1/L2-triggered mobility, LTM, in a wireless network, the method comprising:
   receiving, from the wireless network, an LTM candidate cell configuration;
   executing a first LTM cell switch procedure; and
   transmitting an LTM cell switch complete message to the wireless network, the LTM cell switch complete message including an indication of an applied LTM candidate.
A2. The method of embodiment A1, wherein the LTM cell switch complete message is an RRCReconfigurationComplete message.
A3. The method of embodiment A1 or A2, wherein the method comprises receiving an LTM cell switch command and wherein the executing of the first LTM cell switch procedure is in response to receiving the LTM cell switch command.
A4. The method of any one of embodiments A1-A3, wherein the indication of the applied LTM candidate is or comprises any one of the following:
   an indication or identifier of a cell;
   an indication or identifier of an LTM candidate cell configuration;
   an indication or identifier of a beam;
   an indication or identifier of a RRC message for LTM; and
   an indication that the LTM cell switch complete message is for LTM.
A5. The method of any one of embodiments A1-A4, wherein the LTM cell switch complete message is transmitted to a first target network node, the first target network node controlling the target cell for the first LTM cell switch procedure.
A6. The method of any one of embodiments A1-A4, wherein the method further comprises executing a second LTM cell switch procedure, following the first LTM cell switch procedure, and wherein the LTM cell switch complete message corresponds to the first LTM cell switch procedure but is transmitted to a second target network node, the second target network node controlling the target cell for the second LTM cell switch procedure.
A7. The method of embodiment A6, wherein the method further comprises sending a second LTM cell switch complete message corresponding to the second LTM cell switch procedure, the second LTM cell switch complete message comprising a second indication of an applied LTM candidate.
B1. A method, for a network node in a wireless network, for supporting L1/L2-triggered mobility, LTM, of user equipment, UEs, in the wireless network, the method comprising: receiving, from a UE, a first LTM cell switch complete message, the first LTM cell switch complete message including an indication of an applied LTM candidate.
B2. The method of embodiment B1, wherein the first LTM cell switch complete message is an RRCReconfigurationComplete message.
B3. The method of embodiment B1 or B2, wherein the indication of the applied LTM candidate is or comprises any one of the following:
   an indication or identifier of a cell;
   an indication or identifier of an LTM candidate cell configuration;
   an indication or identifier of a beam;
   an indication or identifier of a RRC message for LTM; and
   an indication that the LTM cell switch complete message is for LTM.
B4. The method of any one of embodiments B1-B3, wherein the network node receiving the LTM cell switch complete message is a first target network node, the first target network node controlling the target cell for the first LTM cell switch procedure.
B5. The method of any one of embodiments B1-B3, wherein the first LTM cell switch complete message corresponds to a first LTM cell switch procedure performed by the UE, to a target cell controlled by a first target network node, but the network node receiving the first LTM cell switch complete message is a second target network node, the second target network node controlling the target cell for a second LTM cell switch procedure.
B6. The method of embodiment B6, wherein the method further comprises receiving a second LTM cell switch complete message corresponding to the second LTM cell switch procedure, the second LTM cell switch complete message comprising a second indication of an applied LTM candidate.
B7. The method of any one of embodiments B1-B6, further comprising sending, to another network node, an indication that execution of an LTM cell switch procedure for the UE was completed.
B8. The method of any one of embodiments B1-B7, further comprising receiving, from another network node, an indication that execution of an LTM cell switch procedure for the UE was completed.
B9. The method of any one of embodiments B1-B8, wherein the method further comprises, prior to receiving the first LTM cell switch complete message, sending, to the UE, an LTM candidate cell configuration.
B10. The method of embodiment B9, further comprising, prior to receiving the first LTM cell switch complete message, sending, to the UE, an LTM cell switch command.
B11. The method of example embodiment B9 or 10, wherein the indication of the applied LTM candidate corresponds to the LTM candidate cell configuration and/or the LTM cell switch command.
B12. The method of example embodiment B9 or 10, wherein the indication of the applied LTM candidate corresponds to another LTM candidate cell configuration and/or another LTM cell switch command.
B13. The method of any one of embodiments B9-12, further comprising receiving, from the UE, a second LTM cell switch complete message, the second LTM cell comprising a second indication of an applied LTM candidate.
B14. The method of embodiment 13, further comprising determining, based on the indications of applied LTM candidate in the first and second LTM cell switch complete messages, that the first and second LTM cell switch complete messages correspond to the same LTM cell switch procedure.
B15. The method of embodiment 13, further comprising determining, based on the indications of applied LTM candidate in the first and second LTM cell switch complete messages, that the first and second LTM cell switch complete messages correspond to different LTM cell switch procedures.
C1. A user equipment (UE) adapted to support L1/L2-triggered mobility (LTM) in a wireless network, the UE comprising:
   communication interface circuitry configured to communicate with the wireless network via at least one serving cell; and
   processing circuitry operably coupled to the communication interface circuitry, wherein the processing circuitry and communication interface circuitry are configured to perform operations corresponding to any of the methods of embodiments A1-A7.
C2. A user equipment (UE) adapted to support L1/L2-triggered mobility (LTM) in a wireless network, he UE being further adapted to perform operations corresponding to any of the methods of embodiments A1-A7.
C3. A non-transitory, computer-readable medium storing computer-executable instructions that, when executed by processing circuitry of a user equipment (UE), configure the UE to perform operations corresponding to any of the methods of embodiments A1-A7.
C4. A computer program product comprising computer-executable instructions that, when executed by processing circuitry of a user equipment (UE), configure the UE to perform operations corresponding to any of the methods of embodiments A1-A7.
D1. A network node adapted to support L1/L2-triggered mobility (LTM) of user equipment (UE) in a wireless network, the network node comprising:
   communication interface circuitry configured to communicate with UEs via at least one serving cell; and
   processing circuitry operably coupled to the communication interface circuitry, wherein the processing circuitry and communication interface circuitry are configured to perform operations corresponding to any of the methods of embodiments B1-B15.
D2. A network node adapted to support L1/L2-triggered mobility (LTM) of user equipment (UE) in a wireless network, the network node being further configured to perform operations corresponding to any of the methods of embodiments B1-B15.
D3. A non-transitory, computer-readable medium storing computer-executable instructions that, when executed by processing circuitry of a network node, configure the RAN node to perform operations corresponding to any of the methods of embodiments B1-B15.
D4. A computer program product comprising computer-executable instructions that, when executed by processing circuitry of a network node, configure the RAN node to perform operations corresponding to any of the methods of embodiments B1-B15.

Below, an example implementation in the 3GPP RRC specification, TS 38.331 v17.4.0, is illustrated for one example of the invention.

Example: Inclusion of an indication of an LTM candidate cell configuration in the RRCReconfigurationComplete message.

```
- RRCReconfigurationComplete
The RRCReconfigurationComplete message is used to confirm the successful completion of an
RRC connection reconfiguration.
  Signalling radio bearer: SRB1 or SRB3
  RLC-SAP: AM
  Logical channel: DCCH
  Direction: UE to Network
```

RRCReconfigurationComplete message
-- ASN1START
-- TAG-RRCRECONFIGURATIONCOMPLETE-START

| | |
|---|---|
| RRCReconfigurationComplete ::= | SEQUENCE { |
| rrc-TransactionIdentifier | RRC-TransactionIdentifier, |
| criticalExtensions | CHOICE { |
| rrcReconfigurationComplete | RRCReconfigurationComplete-IEs, |
| criticalExtensionsFuture | SEQUENCE { } |

}
}

| | |
|---|---|
| RRCReconfigurationComplete-IEs ::= | SEQUENCE { |
| lateNonCriticalExtension | OCTET STRING |

OPTIONAL,

| | |
|---|---|
| nonCriticalExtension | RRCReconfigurationComplete-v1530-IEs |

OPTIONAL
}

| | |
|---|---|
| RRCReconfigurationComplete-v1530-IEs ::= | SEQUENCE { |
| uplinkTxDirectCurrentList | UplinkTxDirectCurrentList |

OPTIONAL,

| | |
|---|---|
| nonCriticalExtension | RRCReconfigurationComplete-v1560-IEs |

OPTIONAL
}

| | |
|---|---|
| RRCReconfigurationComplete-v1560-IEs ::= | SEQUENCE { |
| scg-Response | CHOICE { |
| nr-SCG-Response | OCTET STRING (CONTAINING |

RRCReconfigurationComplete),

| | |
|---|---|
| eutra-SCG-Response | OCTET STRING |

}
OPTIONAL,

| | |
|---|---|
| nonCriticalExtension | RRCReconfigurationComplete-v1610-IEs |

OPTIONAL
}

| | |
|---|---|
| RRCReconfigurationComplete-v1610-IEs ::= | SEQUENCE { |
| ue-MeasurementsAvailable-r16 | UE-MeasurementsAvailable-r16 |

OPTIONAL,

| | |
|---|---|
| needForGapsInfoNR-r16 | NeedForGapsInfoNR-r16 |

OPTIONAL,

| | |
|---|---|
| nonCriticalExtension | RRCReconfigurationComplete-v1640-IEs |

OPTIONAL
}

| | |
|---|---|
| RRCReconfigurationComplete-v1640-IEs ::= | SEQUENCE { |
| uplinkTxDirectCurrentTwoCarrierList-r16 | UplinkTxDirectCurrentTwoCarrierList-r16 |

OPTIONAL,

| | |
|---|---|
| nonCriticalExtension | RRCReconfigurationComplete-v1700-IEs |

OPTIONAL
}

| | |
|---|---|
| RRCReconfigurationComplete-v1700-IEs ::= | SEQUENCE { |
| needForGapNCSG-InfoNR-r17 | NeedForGapNCSG-InfoNR-r17 |

OPTIONAL,

| | |
|---|---|
| needForGapNCSG-InfoEUTRA-r17 | NeedForGapNCSG-InfoEUTRA-r17 |

OPTIONAL,

| | |
|---|---|
| selectedCondRRCReconfig-r17 | CondReconfigId-r16 |

OPTIONAL,

| | |
|---|---|
| nonCriticalExtension | RRCReconfigurationComplete-v1720-IEs |

OPTIONAL
}

| | |
|---|---|
| RRCReconfigurationComplete-v1720-IEs ::= | SEQUENCE { |
| uplinkTxDirectCurrentMoreCarrierList-r17 | UplinkTxDirectCurrentMoreCarrierList-r17 |

OPTIONAL,

| | |
|---|---|
| nonCriticalExtension | RRCReconfigurationComplete-v1800-IEs |

OPTIONAL
}

| | |
|---|---|
| RRCReconfigurationComplete-v1800-IEs ::= | SEQUENCE { |
| isForLTM | LTMCandidateConfigurationId OPTIONAL |

}
-- TAG-RRCRECONFIGURATIONCOMPLETE-STOP
-- ASN1STOP

RRCReconfigurationComplete-IEs field descriptions

needForGapsInfoNR
This field is used to indicate the measurement gap requirement information of the UE for NR target bands.
needForGapNCSG-InfoEUTRA
This field is used to indicate the measurement gap and NCSG requirement information of the UE for E-UTRA
target bands.
needForGapNCSG-InfoNR
This field is used to indicate the measurement gap and NCSG requirement information of the UE for NR target
bands.
isForLTM
This field is used to indicate which RRCReconfiguration message for LTM this RRCReconfigurationComplete
message refer to. The value of this field shall be set the same as the LTMCandidateConfigurationId used to
identify the LTM candidate configuration that is represented by the RRCReconfiguration message for LTM to
which this RRCReconfigurationComplete message refer to.
scg-Response
In case of NR-DC (nr-SCG-Response), this field includes the RRCReconfigurationComplete message. In case of
NE-DC (eutra-SCG-Response), this field includes the E-UTRA RRCConnectionReconfigurationComplete
message as specified in TS 36.331 [10].
selectedCondRRCReconfig
This field indicates the ID of the selected conditional reconfiguration the UE applied upon the execution of CPA or
inter-SN CPC.
uplinkTxDirectCurrentList
The Tx Direct Current locations for the configured serving cells and BWPs if requested by the NW (see
reportUplinkTxDirectCurrent in CellGroupConfig).
uplinkTxDirectCurrentMoreCarrierList
The Tx Direct Current locations for the configured intra-band CA requested by
reportUplinkTxDirectCurrentMoreCarrier-r17.
uplinkTxDirectCurrentTwoCarrierList
The Tx Direct Current locations for the configured uplink intra-band CA with two carriers if requested by the NW
(see reportUplinkTxDirectCurrentTwoCarrier-r16 in CellGroupConfig).

end example
Below, an implementation in the 3GPP F1 AP specification, TS 38.473 v17.4.0, is illustrated for one example of the invention.
begin example
8.3.4 UE Context Modification (gNB-CU initiated)

### 8.3.4.1 General

The Purpose of the UE Context Modification Procedure is to Modify the Established UE Context, e.g., establishing, modifying and releasing radio resources or sidelink resources. This procedure is also used to command the gNB-DU to stop data transmission for the UE for mobility (see TS 38.401 [4]). The procedure uses UE-associated signalling.

### 8.3.4.2 Successful Operation

### Text Omitted

If the Indication of Applied LTM Candidate IE is included in the UE Context Modification Request message, the gNB-DU shall understand that the successful LTM cell switch was performed in the denoted candidate cell.

### Text Omitted

### 9.2.2.7 UE CONTEXT MODIFICATION REQUEST

This message is sent by the gNB-CU to provide UE Context information changes to the gNB-DU. Direction: gNB-CU→gNB-DU

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU UE F1AP ID | M | 9.3.1.4 | | YES | reject |
| gNB-DU UE F1AP ID | M | 9.3.1.5 | | YES | reject |
| SpCell ID | O | NR CGI 9.3.1.12 | Special Cell as | YES | ignore |
| | | | defined in TS 38.321 | | |
| | | | [16]. For handover | | |
| | | | case, this IE is | | |
| | | | considered as target | | |
| | | | cell. | | |
| Text omitted | | | | | |
| Indication of Applied | O | OCTET STRING | Denotes the cell | YES | ignore |
| LTM Candidate | | | where the LTM cell | | |
| | | | switch took place | | |

end example
Some abbreviations:
5GC or 5GCN 5G Core Network
ACK Acknowledgement
AGC Automatic Gain Control
AMF Access and Mobility management Function
AP Application Protocol
ARQ Automatic Repeat Request
BFD Beam Failure Monitoring
BFR Beam Failure Recovery
BSR Buffer Status Report
BWP Bandwidth Part
C-RNTI Cell Radio Network Temporary Identifier
CA Carrier Aggregation
CE Control Element
CGI Cell Global Identity
CHO Conditional Handover
CN Core Network
CPA Conditional PSCell Addition
CPC Conditional PSCell Change
CP Control Plane
CP Cyclic Prefix
CQI Channel Quality Indicator
C-RNTI Cell Radio Network Temporary Identifier
CSI Channel State Information
CU Central Unit
DC Dual Connectivity
DCI Downlink Control Information
DL Downlink
DRB Data Radio Bearer
DU Distributed Unit
eNB (EUTRAN) base station
E-RAB EUTRAN Radio Access Bearer
E-UTRA Evolved Universal Terrestrial Radio Access
E-UTRAN Evolved Universal Terrestrial Radio Access Network
F1 Interface between Central Unit and Distributed Unit
FDD Frequency Division Duplex
gNB NR base station
GTP-U GPRS Tunneling Protocol-User Plane
HARQ Hybrid ARQ
IE Information Element
IP Internet Protocol
LSB Least Significant Bit
LTE Long Term Evolution
LTM L1/L2-Triggered Mobility
MCG Master Cell Group
MAC Medium Access Control
MAC CE MAC Control Element
MCS Modulation and Coding Scheme
MN Master Node
MR-DC Multi-Radio Dual Connectivity
MSB Most Significant Bit
NACK Negative Acknowledgement
NAS Non Access Stratum
NG-RAN Next Generation Radio Access Network
Ng-eNB Next Generation Evolved Node B
NR New Radio
PDCP Packet Data Convergence Protocol
PCell Primary Cell
PCI Physical Cell Identity
PDCCH Physical Downlink Control Channel
PHR Power headroom report
PSCell Primary Secondary Cell (in LTE) or Primary SCG Cell (in NR)
PUCCH Physical Uplink Control Channel
PUSCH Physical Uplink Shared Channel
RACH Random Access Channel
RAT Radio Access Technology
RB Radio Bearer
RB Resource Block
RLC Radio Link Control
RLF Radio Link Failure
RRC Radio Resource Control
SCell Secondary Cell
SCG Secondary Cell Group
SCS Subcarrier Spacing
SCTP Stream Control Transmission Protocol
SeNB Secondary eNB
SgNB Secondary gNB
SINR Signal to Interference plus Noise Ratio
SN Secondary Node
SR Scheduling Request
SRB Signaling Radio Bearer
SSB Synchronization Signal Block
SUL Supplementary uplink
SpCell Special Cell, the primary cell of a master or secondary cell group
TA Timing Advance
TAT Time Alignment Timer
TCI Transmission Configuration Indication
TDD Time Division Duplex
TEID Tunnel Endpoint IDentifier
TNL Transport Network Layer
TPC Transmission Power Control
T-SN Target Secondary Node
UCI Uplink Control Information
UDP User Datagram Protocol
UPF User Plane Function
UE User Equipment
UL Uplink
UL-SCH Uplink Shared Channel
UP User Plane
URLLC Ultra Reliable Low Latency Communication
X2 Interface between base stations
Interface between base stations Xn

1-50. (canceled)

51. A method, for a user equipment (UE), for L1/L2-triggered mobility (LTM) in a wireless network, the method comprising:
receiving, from the wireless network, an LTM candidate cell configuration;
executing a first LTM cell switch procedure; and
transmitting an LTM cell switch complete message to the wireless network, the LTM cell switch complete message including an indication of an applied LTM candidate.

52. The method of claim 51, wherein the LTM cell switch complete message is an RRCReconfigurationComplete message.

53. The method of claim 51, wherein the method comprises receiving an LTM cell switch command and wherein the executing of the first LTM cell switch procedure is in response to receiving the LTM cell switch command.

54. The method of claim 51, wherein the indication of the applied LTM candidate is or comprises an indication or identifier of an LTM candidate cell configuration.

55. The method of claim 51, wherein the LTM cell switch complete message is transmitted to a first target network node, the first target network node controlling the target cell for the first LTM cell switch procedure.

56. A non-transitory computer-readable medium comprising, stored thereupon, a computer program product comprising computer-executable instructions that, when executed by processing circuitry of a user equipment, UE, configure the UE to perform the method of claim 51.

57. A method, for a network node in a wireless network, for supporting L1/L2-triggered mobility (LTM) of user equipment (UEs) in the wireless network, the method comprising:
receiving, from a UE, a first LTM cell switch complete message, the first LTM cell switch complete message including an indication of an applied LTM candidate.

58. The method of claim 57, wherein the first LTM cell switch complete message is an RRCReconfigurationComplete message.

59. The method of claim 57, wherein the indication of the applied LTM candidate is or comprises an indication or identifier of an LTM candidate cell configuration.

60. The method of claim 57, wherein the network node receiving the LTM cell switch complete message is a first target network node, the first target network node controlling the target cell for the first LTM cell switch procedure.

61. A non-transitory computer-readable medium comprising, stored thereupon, a computer program product comprising computer-executable instructions that, when executed by processing circuitry of a network node, configure the network node to perform operations corresponding to the method of claim 57.

62. A user equipment (UE) configured to support L1/L2-triggered mobility (LTM) in a wireless network, the UE comprising
communication interface circuitry configured to communicate with the wireless network, and
processing circuitry and memory operably coupled to the communication interface circuitry, wherein the processing circuitry, memory, and communication interface circuitry are configured to:
receive, from the wireless network, an LTM candidate cell configuration;
execute a first LTM cell switch procedure; and
transmit an LTM cell switch complete message to the wireless network, the LTM cell switch complete message including an indication of an applied LTM candidate.

63. The UE of claim 62, wherein the LTM cell switch complete message is an RRCReconfigurationComplete message.

64. The UE of claim 62, wherein the processing circuitry, memory, and communication interface circuitry are further configured to receive an LTM cell switch command and to execute the first LTM cell switch procedure in response to receiving the LTM cell switch command.

65. The UE of claim 62, wherein the indication of the applied LTM candidate is or comprises an indication or identifier of an LTM candidate cell configuration.

66. The UE of claim 62, wherein the processing circuitry, memory, and communication interface circuitry are configured to transmit the LTM cell switch complete message to a first target network node, the first target network node controlling the target cell for the first LTM cell switch procedure.

67. A network node configured to support L1/L2-triggered mobility (LTM) of user equipment (UE) in a wireless network, the network node comprising communication interface circuitry configured to communicate with UEs via at least one serving cell; and
processing circuitry and memory operably coupled to the communication interface circuitry, wherein the processing circuitry, memory, and communication interface circuitry are configured to:
receive, from a UE, a first LTM cell switch complete message, the first LTM cell switch complete message including an indication of an applied LTM candidate.

68. The network node of claim 67, wherein the first LTM cell switch complete message is an RRCReconfigurationComplete message.

69. The network node of claim 67, wherein the indication of the applied LTM candidate is or comprises an indication or identifier of an LTM candidate cell configuration.

70. The network node of claim 67, wherein the network node receiving the LTM cell switch complete message is a first target network node, the first target network node controlling the target cell for the first LTM cell switch procedure.
